(19) United States
(12) Patent Application Publication
(10) Pub. No.: US 2013/0093155 A1
(43) Pub. Date: Apr. 18, 2013

(54) Shock Absorber Structure of Wheelchair Front Fork

(71) Applicant: Gray Gong, Xiamen City (CN)

(72) Inventor: Gray Gong, Xiamen City (CN)

(21) Appl. No.: 13/391,284

(22) PCT Filed: Sep. 2, 2010
(86) PCT No.: PCT/CN10/76547

§ 371 Date: Feb. 19, 2012

(30) Foreign Application Priority Data
Jul. 8, 2010 (CN) 201020256124.3

(51) Int. Cl. B60G 3/10

(52) U.S. Cl. CPC B60G 3/10
USPC 280/124.121

(57) ABSTRACT

The present invention relates to a shock absorber structure of a wheelchair front fork. A front wheel of the wheelchair is coupled to a fork body at a lower end of a front fork of the wheelchair. A mandrel is installed on the front fork. The front fork includes a U-shaped body at an upper end thereof. The mandrel is connected to an upper piece of the U-shaped body. Through elastic deformation of upper and lower pieces of the U-shaped body, the vibration from the front wheel can be absorbed, providing a shock absorption effect. Compared to the shock absorption device having a spring, the present invention has a simple configuration and is compact and pleasing.

### BACKGROUND OF THE INVENTION

1. Field of the Invention

The present invention relates to a wheelchair, and more particularly to a shock absorber structure of a wheelchair front fork.

2. Description of the Prior Art

The two front wheels of a wheelchair can be turned 360 degrees for the wheelchair to be turned left or right. Though the front wheels are small, they play an important role to the wheelchair. Because the front wheels are small, they are easy to be shocked when applied a force. In order to decrease the vibration of the front wheels, the front wheels are provided with a shock absorption structure. The shock absorption structure of the front wheel of the wheelchair uses a spring which is disposed on the front fork used to secure the front wheel or on the axle of the front fork, such as Chinese Patent Publication No. CN2925443Y published on Jul. 25, 2007 and CN201150606Y published on Nov. 19, 2008. Both patents use a spring for the shock absorption structure of the front fork of the wheelchair. The spring of this structure is fitted on the axle of the front fork or on the front fork, which makes the front wheel larger in size. Besides, the spring is exposed to become rusty. This may influence the shock absorption effect and the appearance of the product. If the spring is installed in an outer sleeve or a casing, it will need additional mating parts. The structure of the product is complicated and the cost is increased. The size and weight of the product are also increased.

Accordingly, the inventor of the present invention has devoted himself based on his many years of practical experiences to solve these problems.

### SUMMARY OF THE INVENTION

The primary object of the present invention is to provide a shock absorber structure of a wheelchair front fork. The shock absorber structure has a simple configuration and is light.

In order to achieve the aforesaid object, a front wheel of a wheelchair is coupled to a fork body at a lower end of a front fork of the wheelchair. A mandrel is installed on the front fork. The front fork comprises a U-shaped body at an upper end thereof. The mandrel is connected to an upper piece of the U-shaped body.

Preferably, an elastic shock absorption block is provided in a U-shaped trough of the U-shaped body.

Preferably, the shock absorption block has an installation hole corresponding in position to the mandrel. When installed, a lower threaded section of the mandrel is inserted in the installation hole and locked by a nut which is disposed under the installation hole.

Preferably, the shock absorption block has an insertion trough corresponding to the upper piece of the U-shaped body of the front fork. When installed, the shock absorption block is connected to the U-shaped body with the upper piece of the U-shaped body to be inserted into the insertion trough.

Preferably, the shock absorption block has two covering plates at two sides thereof.

Preferably, the U-shaped trough of the U-shaped body of the front fork has a closed end and an open end. The closed end has a diameter larger than that of the open end.

Preferably, the shock absorption block corresponds in shape to the U-shaped trough of the U-shaped body. When installed, the shock absorption block is inserted into the U-shaped body from one side of the U-shaped body.

Accordingly, the U-shaped body is disposed on top of the front fork. The mandrel of the wheelchair frame is secured to the upper piece of the U-shaped body. Through elastic deformation of upper and lower pieces of the U-shaped body, the vibration from the front wheel can be absorbed, providing a shock absorption effect. Compared to the shock absorption device having a spring, the present invention has a simple configuration and is compact and pleasing. The U-shaped trough of the U-shaped body can be provided with a shock absorption block made of plastic or metal to enhance its shock absorption effect.

### BRIEF DESCRIPTION OF THE DRAWINGS

FIG. 1 is a perspective view according to a first embodiment of the present invention;

FIG. 2 is a side view according to the first embodiment of the present invention;

FIG. 3 is an exploded view according to a second embodiment of the present invention;

FIG. 4 is a perspective view according to the second embodiment of the present invention;

FIG. 5 is a sectional view according to the second embodiment of the present invention;

FIG. 6 is a perspective view according to a third embodiment of the present invention;

FIG. 7 is a side view according to the third embodiment of the present invention;

FIG. 8 is an exploded view according to a fourth embodiment of the present invention;

FIG. 9 is a perspective view according to the fourth embodiment of the present invention; and

FIG. 10 is a sectional view according to the fourth embodiment of the present invention.

### DETAILED DESCRIPTION OF THE PREFERRED EMBODIMENTS

Embodiments of the present invention will now be described, by way of example only, with reference to the accompanying drawings.

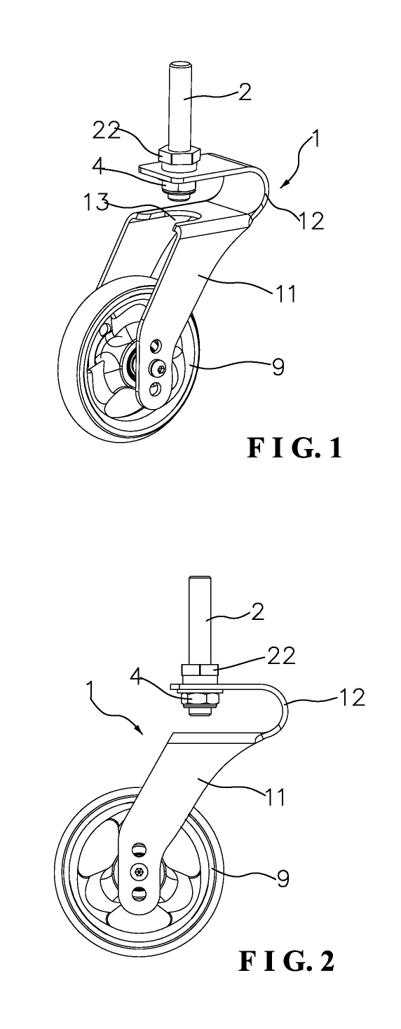

The present invention relates to a shock absorber structure of a wheelchair front fork. FIG. 1 and FIG. 2 show a first embodiment of the present invention. A front wheel 9 of a wheelchair is coupled to a front fork 1. A mandrel 2 is installed on the front fork 1. The upper section of the mandrel 2 is connected to a wheelchair frame through a bearing. The bearing and the wheelchair frame are not shown in the drawings. Through the bearing, the front fork 1 can be turned 360 degrees to bring synchronous rotation of the front wheel.

The front fork 1 comprises a fork body 11 at a lower end thereof for connection of the front wheel 1 and a U-shaped body 12 at an upper end thereof. The mandrel 2 is connected to an upper piece of the U-shaped body 12.

The U-shaped body 12 is disposed on top of the front fork 1. Through elastic deformation of upper and lower pieces of the U-shaped body 12, the vibration from the front wheel 9 can be absorbed, providing a shock absorption effect.

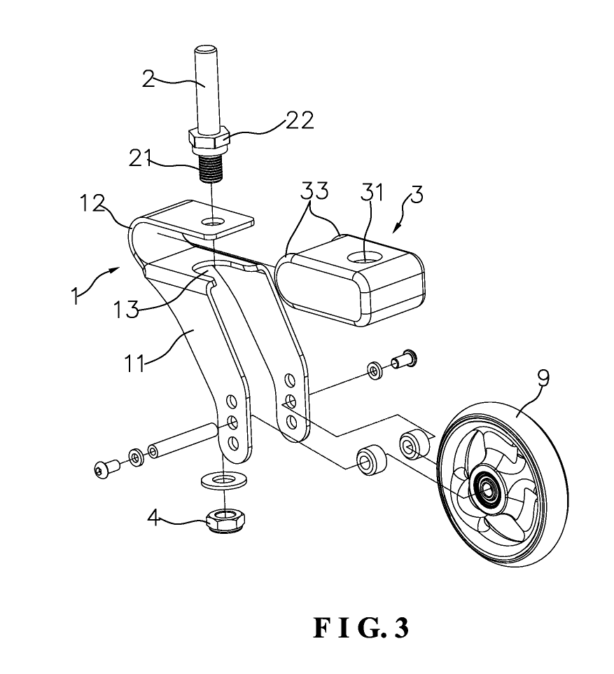

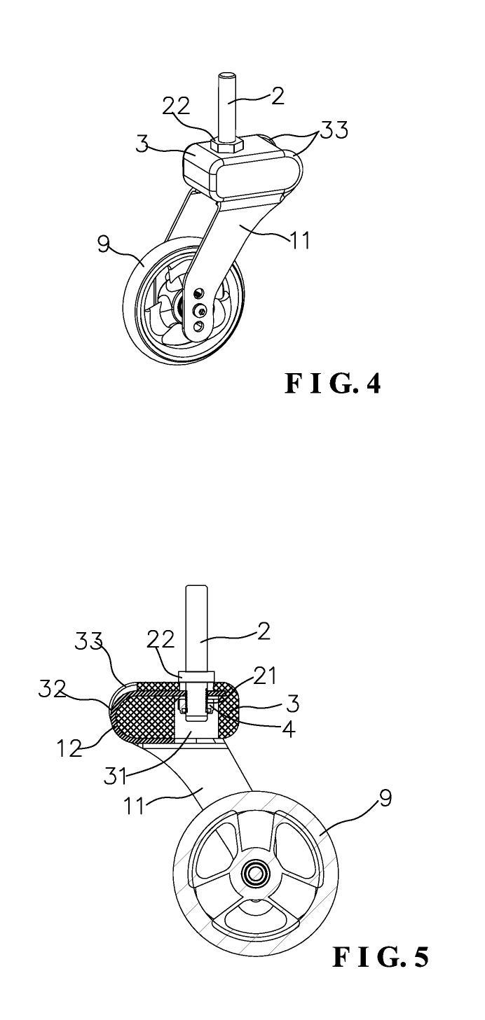

In order to enhance the shock absorption effect, an elastic shock absorption block 3 is provided in a U-shaped trough of the U-shaped body 12. FIG. 3, FIG. 4 and FIG. 5 show a second embodiment of the present invention. The shock absorption block 3 can be made of a plastic material. The shock absorption block 3 is installed in U-shaped trough of the U-shaped body 12 to absorb the vibration from the front wheel, enhancing the shock absorption effect. The user can choose a desired shock absorption block having different hardness according to different use locations. The producer can use different colors to indicate different hardness of the shock absorption block for the user to choose.

For convenient installation, the shock absorption block 3 has an installation hole 31 corresponding in position to the mandrel 2. The lower piece of the U-shaped body 12 has an installation recess 13. When installed, a lower threaded section 21 of the mandrel 2 is inserted in the installation hole 31 and locked by a nut 4 which is disposed under the installation hole 31. Furthermore, in order to secure the shock absorption block 3, the shock absorption block 3 has an insertion trough 32 corresponding to the upper piece of the U-shaped body 12 of the front fork 1. When installed, the shock absorption block 3 is connected to the U-shaped body 12 with the is upper piece of the U-shaped body 12 to be inserted into the insertion trough 32. The lower threaded section 21 of the mandrel 2 is inserted in the installation hole 31 and locked by the nut 4. The mandrel 2 has a protrusion 22 against the upper surface of the shock absorption block 3 so as to secure the shock absorption block 3. In addition, for a pleasing appearance of the product, the shock absorption block 3 has two covering plates 33 at two sides thereof. After installed, the two covering plates 33 cover the U-shaped body 12 in the shock absorption block 3, so that the U-shaped body 12 is covered in the shock absorption block 3. Only the shock absorption block 3 is seen, so the appearance of the product is succinct and pleasing.

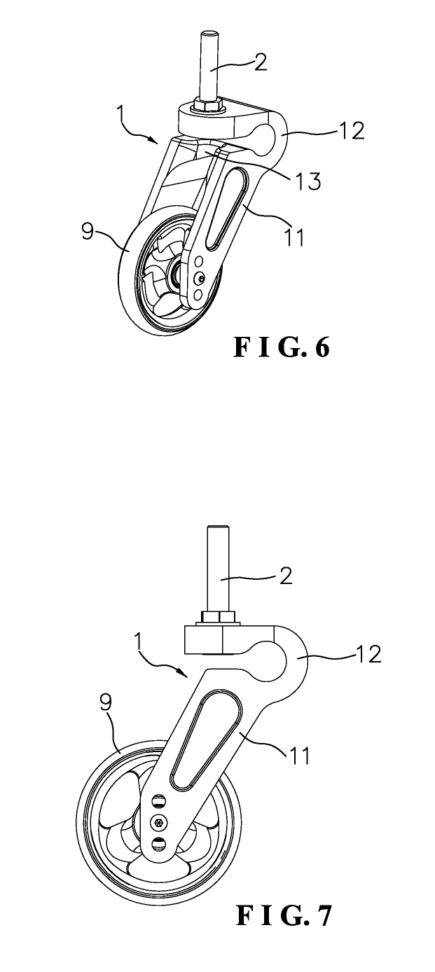

FIG. 6 and FIG. 7 show a third embodiment of the present invention. The third embodiment is substantially similar to the first embodiment with the exceptions described hereinafter. The U-shaped trough of the U-shaped body 12 of the front fork 1 has a closed end and an open end. The closed end has a diameter larger than that of the open end. This configuration is adapted for a front fork made of a plastic material. The strength of plastic is not strong like metal. The front fork of the first and second embodiments can be made of a metallic material. The thickness of the wall of the U-shaped body is smaller and even, which can satisfy the demand of the strength. As to the front fork made of a plastic material, the smaller diameter of the open end can ensure the demand of the strength for the elastic deformation.

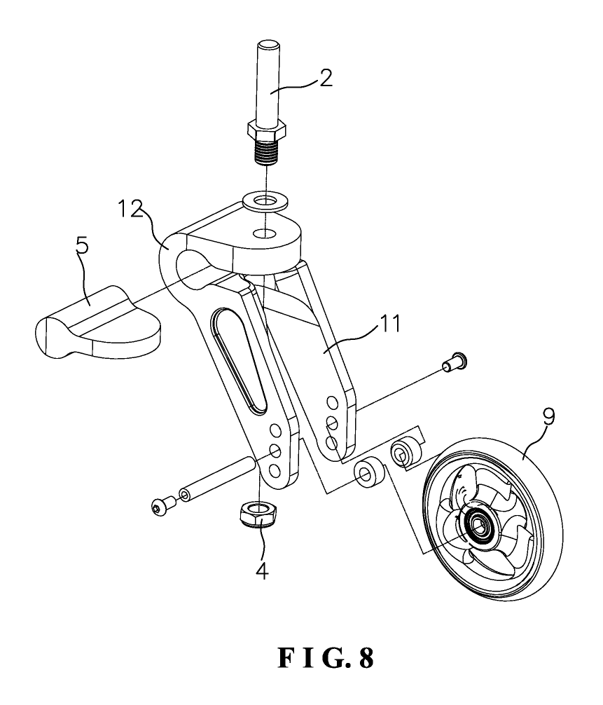

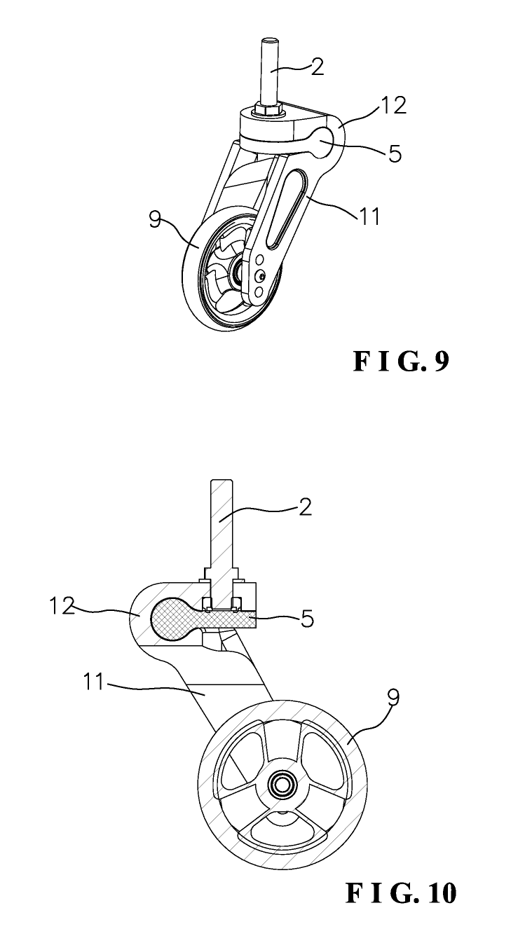

The U-shaped trough of the U-shaped body 12 of the front fork of the aforesaid third embodiment can be provided with a shock absorption block to enhance the shock absorption effect. As shown in FIG. 8 and FIG. 10, the shape of the shock absorption block 5 corresponds to the shape of the U-shaped trough of the U-shaped body 12. When installed, the shock absorption block 5 is inserted into the U-shaped body 12 from one side of the U-shaped body 12.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A shock absorber structure of a wheelchair front fork, a front wheel of a wheelchair being coupled to a fork body at a lower end of a front fork, a mandrel being installed on the front fork, characterized in that: the front fork comprises a U-shaped body at an upper end thereof and the mandrel is connected to an upper piece of the U-shaped body.

2. The shock absorber structure of a wheelchair front fork as claimed in claim 1, wherein an elastic shock absorption block is provided in a U-shaped trough of the U-shaped body.

3. The shock absorber structure of a wheelchair front fork as claimed in claim 2, wherein the shock absorption block has an installation hole corresponding in position to the mandrel, when installed, a lower threaded section of the mandrel being inserted in the installation hole and locked by a nut which is disposed under the installation hole.

4. The shock absorber structure of a wheelchair front fork as claimed in claim 2, wherein the shock absorption block has an insertion trough corresponding to the upper piece of the U-shaped body of the front fork, when installed, the shock absorption block being connected to the U-shaped body with the upper piece of the U-shaped body to be inserted into the insertion trough.

5. The shock absorber structure of a wheelchair front fork as claimed in claim 2, wherein the shock absorption block has two covering plates at two sides thereof.

6. The shock absorber structure of a wheelchair front fork as claimed in claim 1, wherein the U-shaped trough of the U-shaped body of the front fork has a closed end and an open end, the closed end having a diameter larger than that of the open end.

7. The shock absorber structure of a wheelchair front fork as claimed in claim 6, wherein an elastic shock absorption block is provided in a U-shaped trough of the U-shaped body, the shock absorption block corresponding in shape to the U-shaped trough of the U-shaped body, when installed, the shock absorption block being inserted into the U-shaped body from one side of the U-shaped body.
